(19) United States
(12) Patent Application Publication
(10) Pub. No.: US 2024/0208844 A1
(43) Pub. Date: Jun. 27, 2024

(54) METHOD AND SYSTEM FOR WASTEWATER TREATMENT WITH IN-SITU CLEANING OF ELECTRODES

(71) Applicant: AXINE WATER TECHNOLOGIES INC., Vancouver (CA)

(72) Inventor: Victor Ka Lun LEUNG, Burnaby (CA)

(21) Appl. No.: 18/555,228

(22) PCT Filed: Apr. 19, 2022
(86) PCT No.: PCT/US2022/025318

§ 371 Date: Oct. 12, 2023

Related U.S. Application Data
(60) Provisional application No. 63/177,274, filed on Apr. 20, 2021.

(51) Int. Cl. C02F 1/467; C02F 1/00; C02F 1/461; C02F 101/12

(52) U.S. Cl. CPC C02F 1/4674; C02F 1/008; C02F 2001/46119; C02F 2101/12; C02F 2201/4614; C02F 2209/29; C02F 2301/046; C02F 2303/185

(57) ABSTRACT

A system for wastewater treatment with in-situ cleaning of electrodes comprises at least one reactor for treating wastewater comprising a chloride salt (sodium, potassium, calcium etc.) with a chloride concentration between 500 mg/L to 5,000 mg/L and a controller for controlling the current supplied to the reactors by controlling the electrode active area and/or the current density such that the total amount of aqueous free chlorine generated during the wastewater treatment requires the addition of an amount of sodium bisulfite determined experimentally to generate a concentration of between 500 mg/L and 5,000 mg/L of hydrochloric acid and a pH of the treated wastewater of less than or equal to 4. The wastewater is recirculated back to the reactors after the addition of sodium bisulfite in the treated wastewater. This secures an in-situ cleaning of the electrodes within the electrochemical reactors, without the need of any additional equipment.

### TECHNICAL FIELD

The present invention relates to a method and a system for wastewater treatment with in-situ cleaning of electrodes, more specifically for treating wastewater containing chloride.

### BACKGROUND

Wastewater treatment systems are high in demand due to tighter wastewater disposal regulations, whereby industrial facilities are required to eliminate their recalcitrant water pollutants prior to discharge, and due to the current global shortage of clean water. Therefore, there is an increasing demand for cost-effective, sustainable wastewater treatment systems that minimize the addition of chemicals, do not produce secondary pollution, and have minimal operational and maintenance requirements.

The preferred approach to treat recalcitrant wastewater is by electrochemical oxidation, which is a sustainable, safe and highly efficient treatment solution for eliminating a wide variety of pollutants such as persistent organic pollutants, dioxins, nitrogen species (e.g. ammonia), pharmaceuticals, pathogens, microorganisms and others. One approach for treating wastewater is by electrochemical oxidation of organic and/or inorganic pollutants whereby such pollutants are oxidized on the anode surface

In wastewater treatment systems employing electrochemical oxidation the anode catalyst is selected from the group comprising platinum, tin oxide, antimony tin oxide, ruthenium oxide, iridium oxide, niobium doped antimony tin oxide, graphite, manganese oxide, diamond or boron-doped diamond. The electrodes used in wastewater treatment can increase the cost of the overall system especially for applications where a large amount of organic material has to be removed.

Furthermore, the electrodes are subject to fouling and subsequent degradation, becoming less effective for treating the wastewater, due to the contaminant deposition on the surface of the electrodes. Such deposits need to be removed for cleaning the electrodes. In the past, this has generally required stopping the system and manually cleaning or replacing the electrodes depending on the damage caused by the mineral deposits.

The manual cleaning or replacing of the electrodes has been addressed in the past by reversing the polarity of the electric charge applied to the electrolytic cells in the stack, but such a method requires having both the anodes and cathodes in the stack being coated with catalyst for allowing the cell to operate in reverse-polarity. This can be very expensive.

Another method used for cleaning the electrodes has been to add a solution with a low concentration of organic acids such as lactic acid/gluconic acid or citric acid to the wastewater during the treatment process. Such methods require safe supply to the system and discharge from the system of the cleaning solution, which adds to the system's complexity. Furthermore, for some sites with stricter restrictions against introducing chemicals that are not required for treating the wastewater, the addition of an organic acid solution, may not be permitted.

Such a method is presented for example in U.S. Pat. No. 7,722,746 which describes a self-cleaning chlorine-generator that uses a predetermined volume of the pH-reducing agent such as muriatic acid which is introduced into the electrolytic chamber to dissolve the mineral deposits according to a predetermined periodic schedule during the time period when the system is not operating.

U.S. Pat. No. 7,922,890 describes a similar method using an acid created in an acid generation cell, which is separate from the electrolytic cell used for treating a brine solution, the acid being supplied to the electrolytic cell during a cleaning cycle when the electrolytic cell is stopped. The system runs in this acid cleaning mode until a carbonate detector sends a signal that the system is clean and the acid used to clean the electrolytic cell is dumped to a separate waste drain. Then the treatment of the brine solution using the cleaned electrolytic cell can start again.

In the prior art documents, an additional chemical solution, which is not required for the treatment of wastewater or for ensuring safe discharge of the treated wastewater has to be added to the wastewater treatment system for cleaning the electrodes. Such chemical solutions are either added from a supplying tank or are generated in a cell which is separate from the wastewater treatment electrochemical reactor and then are supplied to the electrochemical reactor used for wastewater treatment. This makes the overall system for wastewater treatment more complex and therefore increases its cost.

Notwithstanding the substantial developments in the art, there remains a continuing need for performing an in-situ cleaning of the electrodes without the addition of chemical solutions which are not already used during the wastewater treatment or during the treated water discharge process and having a simplified system which does not have any additional equipment for feeding or generating the chemical solutions used for cleaning the electrodes of the electrochemical reactor(s) used for wastewater treatment.

### SUMMARY OF THE INVENTION

The present invention describes a wastewater treatment system for treating wastewater comprising a chloride salt with a chloride concentration between 500 mg/L to 5,000 mg/L, the system comprising:
a reactor tank;
at least one reactor comprising at least one electrode for treating the wastewater;
a pump for supplying wastewater from the reactor tank to the reactor(s)
a controller for controlling the current supplied to the reactors by a power supply, and
a tank storing sodium bisulfite which is added to the reactor tank at the end of the wastewater treatment when the reactors stop treating the wastewater, for generating an amount of hydrochloric acid in the reactor tank,

wherein the controller controls the current supplied to the reactors such that the total amount of aqueous free chlorine generated until the end of the wastewater treatment requires the addition of an amount of sodium bisulfite determined experimentally to generate a concentration of between 500 mg/L and 5,000 mg/L of hydrochloric acid in the reactor tank and a pH of the treated wastewater in the reactor tank of less than or equal to 4 for in-situ cleaning of the electrodes.

The controller controls the current supplied to the reactors by controlling the size of the active electrode area and/or the density of the current supplied to the reactors.

In some embodiments, the size of the active electrode area is determined experimentally such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of treated wastewater in the reactor tank of less than or equal to 4.

In other embodiments, the size of the electrode active area is controlled based on the amount of aqueous free chlorine detected in the reactor tank during the system operation such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of the treated wastewater in the reactor tank of less than or equal to 4.

In some embodiments, where the current supplied to the reactors is controlled by controlling the current density, the current density is determined experimentally such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of the treated wastewater in the reactor tank of less than or equal to 4.

Alternatively, the current density can be controlled based on the amount of aqueous free chlorine detected during the system operation in the reactor tank such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of treated wastewater in the reactor tank of less than or equal to 4.

Furthermore, in some other embodiments both the size of the electrode active area and the current density are determined experimentally such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of the treated wastewater in the reactor tank of less than or equal to 4.

Yet, in other embodiments, both the electrode active area and the current density are controlled based on the detected amount of aqueous free chlorine such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of treated wastewater in the reactor tank of less than or equal to 4.

A method of wastewater treatment is further disclosed comprising the steps of:
a. supplying a stream of wastewater to be treated which contains a chloride salt with a chloride concentration between 500 to 5,000 mg/L to a reactor tank and from the reactor tank to at least one reactor for treating the wastewater to remove the chloride and the other contaminants contained in the wastewater;
b. controlling the current supplied to the reactor(s) for treating the wastewater;
c. at the end of the treatment, after the reactor(s) stopped treating the wastewater and before the wastewater is discarded from the system, supplying an amount of sodium bisulfite to the treated wastewater in the reactor tank to lower the aqueous free chlorine level below predetermined level allowed for wastewater to be discarded, and
d. recirculating the treated wastewater from the reactor tank through the reactors and back to the reactor tank for a period of time determined experimentally to perform the cleaning of the electrodes of the reactor(s).

The current supplied to the reactor(s) for treating the wastewater is controlled such that the total amount of aqueous free chlorine generated until the end of the wastewater treatment requires the addition of an amount of sodium bisulfite determined experimentally to generate a concentration of between 500 mg/L and 5,000 mg/L of hydrochloric acid in the reactor tank and a pH of the treated wastewater in the reactor tank of less than or equal to 4 for in-situ cleaning of the electrodes.

The current supplied to the reactor(s) can be controlled by controlling the size of the electrode active area of the reactor(s) and/or the current density.

In some embodiments, the size of the active electrode area is controlled to a valued determined experimentally such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of the treated wastewater in the reactor tank of less than or equal to 4.

In other embodiments, the size of the active electrode area is controlled based on the amount of aqueous free chlorine detected during the system operation in the reactor tank such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of the treated wastewater in the reactor tank of less than or equal to 4.

In some embodiments, the current density is controlled to a value determined experimentally such that the amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of the treated wastewater in the reactor tank of less than or equal to 4.

Furthermore, in other embodiments, the current density is controlled based on the amount of aqueous free chlorine detected during the system operation in the reactor tank such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of treated wastewater in the reactor tank of less than or equal to 4.

In some embodiments, both the size of the electrode active area and the current density are determined experimentally such that the total amount of aqueous free chlorine generated until the end of the wastewater treatment requires the addition of an amount of sodium bisulfite determined experimentally to generate a concentration of between 500 and 5,000 mg/L of hydrochloric acid in the reactor tank and a pH of the treated wastewater in the reactor tank of less than or equal to 4.

Furthermore, in other embodiments, both the size of the electrode active area and the current density are controlled based on the detected amount of aqueous free chlorine generated until the end of the wastewater treatment such that the total amount of aqueous free chlorine generated during the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

The present invention is related to a system and to a method for treating wastewater containing a chloride salt (sodium, potassium, calcium etc.).

### BRIEF DESCRIPTION OF THE DRAWINGS

The drawings illustrate specific preferred embodiments of the invention, but should not be considered as restricting the spirit or scope of the invention in any way.

FIG. 1 illustrates a schematic of the system for treating wastewater with in-situ cleaning of electrodes according to the present invention.

### DETAILED DESCRIPTION

Certain terminology is used in the present description and is intended to be interpreted according to the definitions provided below. In addition, terms such as “a” and “comprises” are to be taken as open-ended.

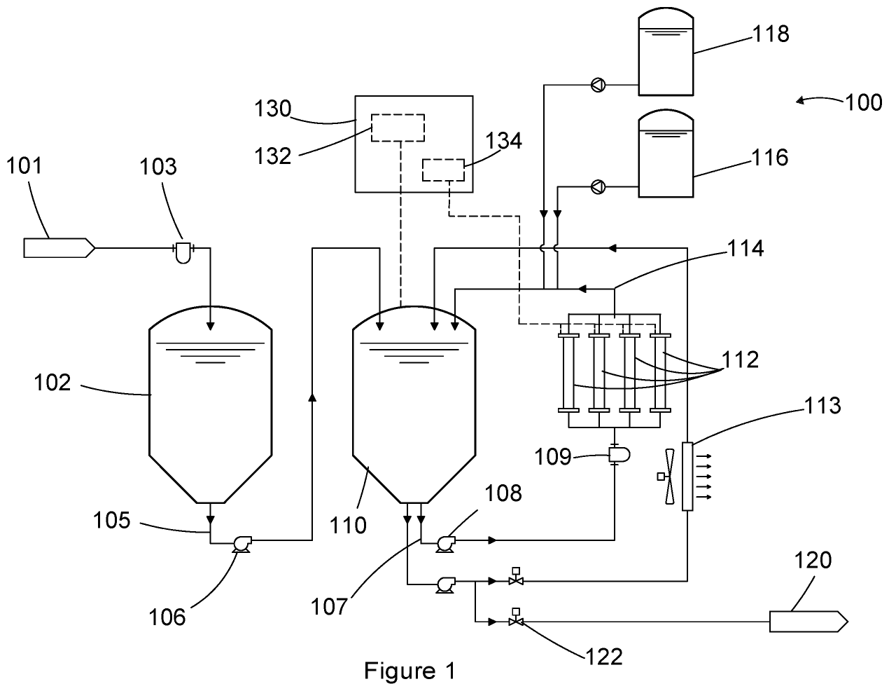

A wastewater treatment system according to the present invention is illustrated in FIG. 1.

The electrochemical wastewater treatment system 100 comprises an equalization tank 102, a reactor tank 110 and at least one reactor 112 comprising a stack of electrolytic cells. The stream of wastewater to be treated 101 is fed through a filter 103 to the equalization tank 102 and the stream of wastewater 105 exiting the equalization tank is fed by a pump 106 to the reactor tank 110. From the reactor tank 110 the stream of wastewater to be treated 107 is fed by a pump 108 through a filter 109 to the reactors 112. The stream of treated wastewater 114 exiting the reactors is recirculated to the reactor tank and the cycle of recirculating the wastewater to be treated through the reactors 112 and back to the reactor tank 110 is repeated as long as required for removing the contaminants from the wastewater at the required level. The time required for removing the contaminants from the wastewater can be determined through experimental testing of the system or by continuously monitoring the contaminant level in the reactor tank. When it is determined that the contaminant level reached in the reactor tank is at or below the level allowed for discarding the water into the environment a solution of sodium bisulfite (SBS) is supplied from tank 118 to the reactor tank 110, to reduce the levels of aqueous free chlorine in the treated wastewater and to lower the pH of the wastewater to be discarded as further explained below and when it is determined that level of aqueous free chlorine and the pH of the wastewater in the tank has reached the required limits, valve 122 is opened and the stream of treated wastewater 120 is discarded from the system.

The present system is also provided with means for adjusting the conductivity of the wastewater being treated. A solution of sodium hydroxide is fed from the tank 116 through a pump to the stream of treated wastewater 114 which is recirculated to the reactor tank 110. In preferred embodiments, the temperature of the wastewater in the reactor tank is maintained within predetermined limits by circulating at least a part of the wastewater from the reactor tank 110 through a radiator 113.

The system further comprises a controller 130 which receives information from an operational data collector device 132 and controls the power supply 134 which provides current to the reactors 112. The operational data collector device 132 collects information about the contaminant concentration in the reactor tank and the amount of aqueous free chlorine in the reactor tank, among other parameters. The amount of aqueous free chlorine in the reactor tank is provided to the data collector device by a sensor which monitors the oxidation reduction potential of the wastewater.

The present invention is related to a system and to a method for treating wastewater containing a chloride salt (sodium, potassium, calcium etc.). In the examples described herein the wastewater to be treated contains sodium chloride, but a person skilled in the art would understand that similar chemical reactions take place during the electrochemical treatment of wastewater containing potassium chloride, calcium chloride etc. and the system and the method described in the present invention refer to wastewater containing any type of chloride. During the electrochemical oxidation treatment process of the wastewater to be treated, the chloride ions from the wastewater will be oxidized into aqueous free chlorine. Because of the requirement to ensure that the aqueous free chlorine generated during the wastewater treatment does not evolve into chlorine gas, the pH of the wastewater is controlled during treatment to be higher than about 9 which ensures that all the aqueous free chlorine generated during the treatment process remains in aqueous phase as hypochlorite as per the following reaction:

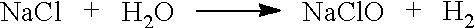

Because of the restrictions on the levels of chlorine that can be discharged from the wastewater treatment system, sodium bisulfite (SBS) is added to the treated wastewater after the treatment is stopped and before it is discharged into the environment to neutralize the hypochlorite into hydrochloric acid and sulfuric acid, as illustrated in the following reaction:

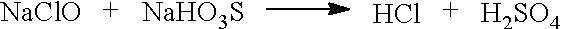

The addition of sodium bisulfite results in a decrease in the pH of the treated water depending on the aqueous free chlorine content. It was found that, for the systems used in the past for treating wastewater containing sodium chloride, the pH of the wastewater after the addition of sodium bisulfite to neutralize the aqueous free chlorine drops to around 6 to 8.

It was also determined that if the hypochlorite generation is increased, more sodium bisulfite would be required to neutralize the aqueous free chlorine, resulting in a further drop in pH of the treated wastewater to around 4 or below, which is beneficial for dissolving the hardness scales deposited on the electrodes surfaces if the treated wastewater is recirculated through the reactors. As it was found, the dissolution of the hardness deposits is enhanced due to the exchange between the chloride ions and carbonate ions in the hardness scales, which results in the hardness scales deposited on the electrodes surfaces dissolving in the treated water.

The present system and method are designed for treating wastewater containing a chloride salt with a chloride concentration between 500 mg/L and 5,000 mg/L and addressing this problem of dropping the pH of the treated wastewater to be discharged to below around 4 for in-situ cleaning of the electrodes by increasing the amount of chemical solutions generated within the wastewater treatment reactor, not by providing such chemical solutions for cleaning the electrodes from an external electrolytic cell and without using any additional chemicals that are not already involved in the wastewater treatment process.

According to a preferred embodiment of the invention, the current supplied to the reactors is controlled by the controller 130 such that the total amount of aqueous free chlorine generated during treatment would require the addition of an amount of sodium bisulfite to generate an amount of hydrochloric acid in the range of 500 mg/L to 5,000 mg/L and such that the pH of the treated wastewater is less than or equal to 4. The current to be supplied to the reactors to meet these requirements can be determined experimentally through tests run in the lab for the water to be treated or it can be actively controlled during operation by monitoring the amount of aqueous free chlorine generated during treatment. As mentioned above the amount of aqueous free chlorine generated during the wastewater treatment is monitored by a sensor which monitors the oxidation reduction potential of the wastewater.

The current supplied to the reactors 112 can be controlled either by controlling the size of the electrode active area of the reactors 112 or by controlling the current density. The electrode active area is defined as the total area of the electrodes in the reactors 112 that are active, are supplied with current from the power supply 134 and are treating the wastewater. A person skilled in the art would understand that the system can be provided with only one reactor 112, and in this case the electrode active area is defined by the area of electrodes in the reactor that are supplied with current from the power supply and which operate to treat the wastewater. Controller 130 controls the density of the current supplied to the reactors 112 and/or the number of electrodes or reactors connected to power to achieve the desired current supplied to the reactors according to the above mentioned conditions.

The method for operating the present system described above and illustrated in FIG. 1 can be summarized as follows. The stream of wastewater to be treated 101 is supplied to the equalization tank 102 and further through the pump 106 to the reactor tank 110. From the equalization tank 110 the wastewater to be treated 107 is supplied to the reactors 112 which are connected to the power supply and the wastewater treatment takes place within the reactors. The treated wastewater 114 is recirculated back to the reactor tank 110 and the cycle is repeated for a period of time determined experimentally to reduce the contaminant concentration in the wastewater to the limits allowed for discarding the treated wastewater. The contaminant concentration in the wastewater in the reactor tank is monitored by the operational data collector device 132 and it is communicated to the controller which stops providing power to the reactors 112 when the contaminant concentration has reached the desired level.

During the treatment process the operational data collector device 132 also collects information about the wastewater in the reactor tank 110 such as the amount of aqueous free chlorine generated during the treatment process.

After the wastewater has been treated and before it is discarded from the system, the reactors 112 are disconnected from the power supply, a sodium bisulfite solution is supplied from the tank 118 to the reactor tank 110, the pH of the wastewater in the reactor tank is monitored by data collector device 132 and when the pH of the wastewater in the tank has reached 4 or below the wastewater is recirculated through reactors 112 and back to the tank for an amount of time determined experimentally to achieve the in-situ cleaning of the electrodes. Thereafter, the stream of treated wastewater 120 is discharged from the system.

The current supplied to the reactors during wastewater treatment is controlled such that the sodium hypochlorite generated during the wastewater treatment will produce between 500 to 5,000 mg/L of hydrochloric acid in the reactor tank after the addition of sodium bisulfite and will cause the pH of the treated wastewater to become less than or equal to 4. The amount of current to be supplied to the reactors is determined either experimentally through tests performed in the lab for the specific characteristics of the wastewater to be treated or by continuously monitoring the amount of aqueous free chlorine in the reactor tank 110 during the wastewater treatment through the data collection device 132.

The current supplied to the reactors is controlled to achieve the above requirements by controlling the size of the electrode active area of the reactors used for wastewater treatment or by controlling the density of the current supplied to the reactors. In some embodiments, both the size of the electrode active area and the current density are controlled based on the above requirements.

Therefore, in some embodiments, the size of electrode active area is controlled such that the total amount of aqueous free chlorine generated until the end of the of the wastewater treatment requires the addition of an amount of sodium bisulfite determined experimentally to generate a concentration of between 500 to 5,000 mg/L of hydrochloric acid in the reactor tank and causing the pH of the treated wastewater to become less than or equal to 4 after the dosing of the sodium bisulfite solution. The required size of the electrode active area can be determined either experimentally through tests performed in the lab for the specific characteristics of the wastewater to be treated or by continuously monitoring the level of aqueous free chlorine in the reactor tank 110 during the wastewater treatment through the data collection device 132. Generally if the determination of the size of required electrode active area is done through lab tests, the electrode active area will be maintained the same during the wastewater treatment, while if the determination of the size of the electrode active area is based on monitoring the level of aqueous free chlorine, the size of the electrode active area could be varied during the wastewater treatment operation depending on the detected aqueous free chlorine levels by increasing or decreasing the number of reactors in operation or, if only one electrochemical reactor is used, by increasing or decreasing the number of active electrodes which are connected to the power supply.

In other embodiments, the density of the current provided by the power supply 134 to the reactors 112 is controlled such that the total amount of aqueous free chlorine generated until the end of the of the wastewater treatment requires the addition of an amount of sodium bisulfite determined experimentally to generate a concentration of between 500 to 5,000 mg/L of hydrochloric acid in the reactor tank and will cause the pH of the treated wastewater to become less than or equal to 4 after the dosing of the sodium bisulfite. The current density can be determined either experimentally through tests performed in the lab for the specific characteristics of the wastewater to be treated or by continuously monitoring the level of aqueous free chlorine in the reactor tank 110 during the wastewater treatment through the data collection device 132. As with the electrode active area, if the current density is determined experimentally, it will be generally maintained constant during the wastewater treatment operation, while if the current density is determined based on continuously monitoring the level of aqueous free chlorine in the reactor tank during the wastewater treatment, it could vary during the wastewater treatment operation according to the detected aqueous free chlorine levels.

In alternate embodiments, both the size of the active electrode area and the current density of the power supplied to the reactors are controlled at the same time such that the total amount of aqueous free chlorine generated until the end of the of the wastewater treatment requires the addition of an amount of sodium bisulfite determined experimentally to generate a concentration of between 500 to 5,000 mg/L of hydrochloric acid in the reactor tank and will cause the pH of the treated wastewater to become less than or equal to 4 after the dosing of the sodium bisulfite. The values of the active electrode area and of the current density can be determined either experimentally through tests performed in the lab for the specific characteristics of the wastewater to be treated or by continuously monitoring the level of aqueous free chlorine in the reactor tank 110 during the wastewater treatment through the data collection device 132. The same as in the previous embodiments, the values of the size of the electrode active area and of the current density can be constant, if determined experimentally, or could vary during the wastewater treatment operation, if they are based on the monitored level of aqueous free chlorine generated during treatment.

In all embodiments, the active electrode area and/or the current density of the power supplied to the reactors, required for generating a concentration of between 500 to 5,000 mg/L of hydrochloric acid in the reactor tank and/or causing the pH of the treated wastewater to become less than or equal to 4 after the dosing of the sodium bisulfite according to the present invention, is higher than the active electrode area and/or the current density supplied to the reactor(s) just for treating the wastewater to reduce the contaminant concentration so that the wastewater discharge requirements are met.

The advantage of the present system and method compared to the prior art is that no additional chemical solution, which is not required for the treatment of wastewater or for ensuring safe discharge of the treated wastewater is added to the wastewater treatment system for cleaning the electrodes. It is known that in wastewater systems sodium bisulfite is added to the treated wastewater, but in different amounts than presently described, to neutralize the hypochlorite into hydrochloric acid and sulfuric acid to meet the wastewater discharge requirements.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, if any, including U.S. Provisional Patent Application No. 63/177,274, filed Apr. 20, 2021, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A wastewater treatment system for treating wastewater comprising a chloride salt with a chloride concentration between 500 mg/L to 5,000 mg/L comprising:
a. a reactor tank;
b. at least one reactor comprising at least one electrode for treating the wastewater;
c. a pump for supplying wastewater from the reactor tank to the reactor(s)
d. a controller for controlling the current supplied to the reactors by a power supply, and
e. a tank storing sodium bisulfite which is added to the reactor tank at the end of the wastewater treatment when the reactors stop treating the wastewater, for generating an amount of hydrochloric acid in the reactor tank,
wherein the controller controls the current supplied to the reactors such that the total amount of aqueous free chlorine generated until the end of the wastewater treatment requires the addition of an amount of sodium bisulfite determined experimentally to generate a concentration of between 500 mg/L and 5,000 mg/L of hydrochloric acid in the reactor tank and a pH of the treated wastewater in the reactor tank of less than or equal to 4 for in-situ cleaning of the electrodes.

2. The system of claim 1 wherein the controller controls the current supplied to the reactors by controlling the size of the active electrode area and/or the density of the current supplied to the reactors.

3. The system of claim 2 wherein the size of the active electrode area is determined experimentally such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

4. The system of claim 2 wherein the size of the electrode active area is controlled based on the amount of aqueous free chlorine detected in the reactor tank during the system operation such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

5. The system of claim 2 wherein the current density is determined experimentally such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

6. The system of claim 2 wherein the current density is controlled based on the amount of aqueous free chlorine detected during the system operation in the reactor tank such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

7. The system of claim 2 wherein both the size of the electrode active area and the current density are determined experimentally such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

8. The system of claim 2 wherein both the size of the electrode active area and the current density are controlled based on the detected amount of aqueous free chlorine such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of treated wastewater in the reactor tank of less than or equal to 4.

9. A method of wastewater treatment comprising the steps of:
a. supplying a stream of wastewater to be treated which contains a chloride salt with a chloride concentration between 500 mg/L to 5,000 mg/L to a reactor tank and from the reactor tank to at least one reactor for treating the wastewater to remove the chloride and the other contaminants contained in the wastewater;
b. controlling the current supplied to the reactor(s) for treating the wastewater;
c. at the end of the treatment, after the reactor(s) stopped treating the wastewater and before the wastewater is discarded from the system, supplying an amount of sodium bisulfite to the treated wastewater in the reactor tank to lower the aqueous free chlorine level below predetermined level allowed for wastewater to be discarded, and
d. recirculating the treated wastewater from the reactor tank through the reactors and back to the reactor tank for a period of time determined experimentally to perform the cleaning of the electrodes of the reactor(s),
wherein the current supplied to the reactor(s) for treating the wastewater is controlled such that the total amount of aqueous free chlorine generated until the end of the wastewater treatment requires the addition of an amount of sodium bisulfite determined experimentally to generate a concentration of between 500 mg/L and 5,000 mg/L of hydrochloric acid in the reactor tank and a pH of the treated wastewater in the reactor tank of less than or equal to 4 for in-situ cleaning of the electrodes.

10. The method of claim 9 wherein the current supplied to the reactor(s) is controlled by controlling the size of the electrode active area of the reactor(s) and/or the current density.

11. The method of claim 10 wherein the size of the electrode active area is controlled to a valued determined experimentally such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

12. The method of claim 10 wherein the size of the electrode active area is controlled based on the amount of aqueous free chlorine detected during the system operation in the reactor tank such that the total amount of aqueous free chlorine generated during until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

13. The method of claim 10 wherein the current density is controlled to a value determined experimentally such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

14. The method of claim 10 wherein the current density is controlled based on the amount of aqueous free chlorine detected during the system operation in the reactor tank such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

15. The method of claim 10 wherein both the size of the electrode active area and the current density are determined experimentally such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

16. The method of claim 10 wherein both the size of the electrode active area and the current density are controlled based on the detected amount of aqueous free chlorine generated until the end of the wastewater treatment such that the total amount of aqueous free chlorine generated until the end of the wastewater treatment requires the addition of an amount of sodium bisulfite determined experimentally to generate the concentration of between 500 and 5,000 mg/L of hydrochloric acid in the reactor tank and the pH of the treated wastewater in the reactor tank of less than or equal to 4.

17. The method of claim 9 wherein the chloride salt is sodium chloride.
